(19) United States
(12) Patent Application Publication
(10) Pub. No.: US 2013/0123451 A1
(43) Pub. Date: May 16, 2013

(54) PRESSURE-SENSITIVE ADHESIVE SHEET

(71) Applicant: Nitto Denko Corporation, Osaka (JP)

(72) Inventors: Ai TAKEDA, Osaka (JP); Hiroaki KISHIOKA, Osaka (JP)

(73) Assignee: NITTO DENKO CORPORATION, Osaka (JP)

(21) Appl. No.: 13/676,634

(22) Filed: Nov. 14, 2012

(30) Foreign Application Priority Data
Nov. 15, 2011 (JP) 2011-249461

(51) Int. Cl. C09J 133/12; C09J 139/06

(52) U.S. Cl. CPC C09J 133/12; C09J 139/06
USPC 526/263; 526/320

(57) ABSTRACT

The present invention provides a pressure-sensitive adhesive sheet excellent in anti-white turbidity and anti-foaming release property under a high-temperature and high-humidity environment and corrosion resistance. The invention provides a pressure-sensitive adhesive sheet including a pressure-sensitive adhesive layer which includes an acrylic polymer (A) and has a gel fraction of 70 to 100 wt %, wherein the acrylic polymer (A) is formed from a component including, as an essential monomer component, methyl methacrylate and a hydroxyl group-containing monomer in an amount of 10 to 40 wt % based on a total amount (100 wt %) of the monomer component, the component forming the acrylic polymer (A) substantially does not contain a carboxyl group-containing monomer.

### BACKGROUND OF THE INVENTION

1. Technical Field

The present invention relates to a pressure-sensitive adhesive sheet.

2. Background Art

Recently, in various fields, display devices such as a liquid crystal display (LCD) or an input device used by combining with the display device, such as a touch panel, has been widely used. In the display device or the input device, a pressure-sensitive adhesive tape or sheet is used for laminating an optical member. For example, a transparent pressure-sensitive adhesive sheet is used for laminating the touch panel and various kinds of display members optical members (for example, see Patent Documents 1 to 3).

Patent Document 1: JP 2003-238915 A

Patent Document 2: JP 2003-342542 A

Patent Document 3: JP 2004-231723 A

### SUMMARY OF THE INVENTION

With extension of use embodiments of the display device and the input device, the pressure-sensitive adhesive sheet for use in these devices has been required to have high transparency even under various environments and not to generate foaming and release. Specifically, the pressure-sensitive adhesive sheet has been required not to exert an adverse effect on appearance of an optical member, an optical product or the like containing the pressure-sensitive adhesive sheet laminated thereto and visibility of a display part (image display part) thereof, without whitening (white turbidity) under a high-temperature and high-humidity environment and to be less likely to generate foaming and release at the interface between the pressure-sensitive adhesive sheet and an adherend under a high-temperature and high-humidity environment.

Furthermore, the above pressure-sensitive adhesive sheet has been also required to exhibit corrosion-resistant performance when the pressure-sensitive adhesive sheet is laminated to an adherend (particularly, a metal thin film such as a metal oxide thin film).

Therefore, an object of the present invention is to provide a pressure-sensitive adhesive sheet which is excellent in anti-white turbidity (a property of being less likely to generate whitening (white turbidity) of the pressure-sensitive adhesive sheet owing to moisture) and anti-foaming release property (a property of being less likely to generate foaming and release at the interface between the pressure-sensitive adhesive sheet and the adherend) under a high-temperature and high-humidity environment and is further excellent in corrosion resistance (a property of occurring no corrosion of the adherend and the like).

Accordingly, as a result of extensive studies, the present inventors have found that a pressure-sensitive adhesive sheet excellent in anti-white turbidity under a high-temperature and high-humidity environment, excellent in anti-foaming release property under a high-temperature and high-humidity environment, and further excellent in corrosion resistance is obtained when the pressure-sensitive adhesive layer of the pressure-sensitive adhesive sheet contains an acrylic polymer being formed from a component including, as an essential monomer component, methyl methacrylate and a hydroxyl group-containing monomer, wherein a content of the hydroxyl group-containing monomer based on a total amount (100 wt %) of the monomer component forming the acrylic polymer falls within a certain range, the component forming the acrylic polymer substantially does not contain a carboxyl group-containing monomer, and a gel fraction of the pressure-sensitive adhesive sheet falls within a certain range. The present invention has been completed based on these findings.

The present invention provides a pressure-sensitive adhesive sheet including a pressure-sensitive adhesive layer, wherein

the pressure-sensitive adhesive layer includes an acrylic polymer (A),

the acrylic polymer (A) is formed from a component comprising, as an essential monomer component, methyl methacrylate and a hydroxyl group-containing monomer,

a content of the hydroxyl group-containing monomer based on a total amount (100 wt %) of the monomer component forming the acrylic polymer (A) is 10 to 40 wt %,

the component forming the acrylic polymer (A) substantially does not contain a carboxyl group-containing monomer, and

a gel fraction of the pressure-sensitive adhesive layer is 70 to 100 wt %.

In the pressure-sensitive adhesive sheet, the acrylic polymer (A) is preferably obtained by crosslinking an acrylic polymer (B) having a weight average molecular weight of 400,000 to 900,000.

In the pressure-sensitive adhesive sheet, a content of the methyl methacrylate based on the total amount (100 wt %) of the monomer component forming the acrylic polymer (A) is preferably more than 0 wt % and 30 wt % or less.

The pressure-sensitive adhesive sheet is preferably an optical pressure-sensitive adhesive sheet.

Since the pressure-sensitive adhesive sheet of the present invention has the above-described constitution, the pressure-sensitive adhesive sheet is excellent in anti-white turbidity and anti-foaming release property under a high-temperature and high-humidity environment and is further excellent in corrosion resistance.

### BRIEF DESCRIPTION OF THE DRAWINGS

FIG. 1 is a schematic cross-sectional view showing a test piece, which is used for evaluation of anti-white turbidity.

FIG. 2 is a schematic cross-sectional view showing a test piece, which is used for evaluation of anti-foaming release property.

FIG. 3 is a schematic view (plane view) showing a sample for measuring a resistance value, which is used for evaluation of corrosion resistance.

FIG. 4 is a schematic view (line A-A′ cross-sectional view in FIG. 3) showing a sample for measuring a resistance value, which is used for evaluation of corrosion resistance.

### DETAILED DESCRIPTION OF THE INVENTION

The pressure-sensitive adhesive sheet of the present invention is a pressure-sensitive adhesive sheet including at least one pressure-sensitive adhesive layer (pressure-sensitive adhesive layer of the present invention). The pressure-sensitive adhesive layer is a “pressure-sensitive adhesive layer containing an acrylic polymer (A), wherein the acrylic polymer (A) is formed from a component including, as an essential monomer component, methyl methacrylate and a hydroxyl group-containing monomer, a content of the hydroxyl group-containing monomer based on a total amount (100 wt %) of the monomer component forming the acrylic polymer (A) is 10 to 40 wt %, the component forming the acrylic polymer (A) substantially does not contain a carboxyl group-containing monomer, and a gel fraction of the pressure-sensitive adhesive layer is 70 to 100 wt %”. In the present specification, the above pressure-sensitive adhesive layer is sometimes referred to as the “pressure-sensitive adhesive layer of the present invention”.

In the present specification, the “pressure-sensitive adhesive sheet” is meant to include a “pressure-sensitive adhesive tape”. In addition, the surface of a pressure-sensitive adhesive layer in the pressure-sensitive adhesive sheet may be called “pressure-sensitive adhesive surface”.

(Pressure-Sensitive Adhesive Layer of the Present Invention)

The pressure-sensitive adhesive layer of the present invention contains at least an acrylic polymer (A). The acrylic polymer (A) is an “acrylic polymer being formed from a component including, as an essential monomer component, methyl methacrylate and a hydroxyl group-containing monomer, wherein a content of the hydroxyl group-containing monomer based on a total amount (100 wt %) of the monomer component forming the polymer is 10 to 40 wt %, and the component forming the acrylic polymer substantially does not contain a carboxyl group-containing monomer”.

The pressure-sensitive adhesive layer of the present invention is an acrylic pressure-sensitive adhesive layer including at least an acrylic polymer (A). The content of the acrylic polymer (A) in the pressure-sensitive adhesive layer of the present invention is not particularly limited, and is preferably 70 wt % or more (for example, 70 to 100 wt %), and more preferably 85 wt % or more (for example, 85 to 100 wt %) based on the total amount (100 wt %) of the pressure-sensitive adhesive.

The pressure-sensitive adhesive layer of the present invention is preferably formed from a pressure-sensitive adhesive composition. The meaning of the “pressure-sensitive adhesive composition” includes a “composition for forming a pressure-sensitive adhesive”.

In the acrylic polymer (A), the acrylic polymer being formed from a component including, as an essential monomer component, methyl methacrylate and a hydroxyl group-containing monomer means that the acrylic polymer contains, as an essential structural unit, a structural unit derived from methyl methacrylate and a structural unit derived from the hydroxyl group-containing monomer.

From the viewpoints of anti-foaming property and white turbidity of the polymer, the component forming the acrylic polymer (A) preferably includes, as an essential monomer component, methyl methacrylate, the hydroxyl group-containing monomer, and an alkyl(meth)acrylate having a linear or branched alkyl group other than methyl methacrylate. The “(meth)acryl” means “acryl” and/or “methacryl” (any one or both of “acryl” and “methacryl”), and the same shall apply hereinafter.

Namely, the acrylic polymer (A) preferably contains a structural unit derived from methyl methacrylate, a structural unit derived from the hydroxyl group-containing monomer, and a structural unit derived from an alkyl(meth)acrylate having a linear or branched alkyl group other than methyl methacrylate, as essential structural units.

The component forming the acrylic polymer (A) includes methyl methacrylate as an essential monomer component. The pressure-sensitive adhesive sheet of the present invention can exhibit excellent anti-foaming release property under a high-temperature and high-humidity environment when methyl methacrylate is contained as a monomer component forming the acrylic polymer (A). In the present specification, the term “under a high-temperature and high-humidity environment” means, for example, “under an environment of a temperature of 40 to 85° C. and a humidity of 85 to 95% RH”.

The content of methyl methacrylate based on the total amount (100 wt %) of monomer components forming the acrylic polymer (A) is not particularly limited, but is preferably in a range of more than 0 wt % and 30 wt % or less and is more preferably 7 to 25 wt %, further preferably 8 to 20 wt %, and still more preferably 9 to 17 wt %. When methyl methacrylate is contained as a monomer component forming the acrylic polymer (A), the anti-foaming release property under a high-temperature and high-humidity environment and adhesiveness to an adherend (particularly, an acrylic resin-made adherend or a polycarbonate-made adherend) under a high-temperature and high-humidity environment are easily improved, so that the case is preferable. Furthermore, the whitening (white turbidity) of the polymer owing to moisture can be effectively suppressed, so that the case is preferable. Moreover, when the content of methyl methacrylate is 30 wt % or less, appropriate flexibility can be obtained and thus pressure-sensitive adhesion property and step absorbability are easily improved, so that the case is preferable.

As the alkyl(meth)acrylate having a linear or branched alkyl group other than the methyl methacrylate (which may be simply referred to as “alkyl(meth)acrylate” in this specification), examples thereof include an alkyl(meth)acrylate having an alkyl group having 1 to 20 carbon atoms, such as methyl acrylate, ethyl(meth)acrylate, propyl(meth)acrylate, isopropyl(meth)acrylate, n-butyl(meth)acrylate, isobutyl(meth)acrylate, s-butyl(meth)acrylate, t-butyl(meth)acrylate), pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Among them, as the alkyl(meth)acrylate, an alkyl(meth)acrylate having an alkyl group having 1 to 12 carbon atoms is preferable from the standpoint of the productivity and pressure-sensitive adhesive property; and n-butyl acrylate (BA), ethyl acrylate (EA) and 2-ethylhexyl acrylate (2EHA) are more preferable. The alkyl(meth)acrylate may be used either alone or in combination of two or more thereof.

The content of the above alkyl(meth)acrylate based on the total amount (100 wt %) of monomer components forming the acrylic polymer (A) is not particularly limited, but is preferably 40 to 75 wt %, more preferably 45 to 70 wt %, and further preferably 50 to 65 wt % from the viewpoint of obtaining good pressure-sensitive adhesion properties.

The component forming the acrylic polymer (A) includes the hydroxyl group-containing monomer as an essential monomer component. The hydroxyl group-containing monomer is a monomer having at least one hydroxyl group in a molecule thereof (in one molecule thereof). It is presumed that the hydroxyl group-containing monomer suppresses aggregation of moisture in the pressure-sensitive adhesive sheet when the hydroxyl group-containing monomer is included as an essential monomer component forming the acrylic polymer (A). Therefore, although a general pressure-sensitive adhesive sheet is sometimes whitened resulting from moisture when the pressure-sensitive adhesive sheet absorbs the moisture, the pressure-sensitive adhesive sheet of the present invention is not whitened under a high-temperature and high-humidity environment. The hydroxyl group-containing monomer may be used alone or in combination of two or more thereof.

Examples of the hydroxyl group-containing monomer include hydroxyl group-containing (meth)acrylic acid ester, such as 2-hydroxyethyl(meth)acrylate, 3-hydroxypropyl(meth)acrylate, 4-hydroxybutyl(meth)acrylate, 6-hydroxyhexyl(meth)acrylate, hydroxyoctyl(meth)acrylate, hydroxydecyl(meth)acrylate, hydroxylauryl(meth)acrylate and (4-hydroxymethylcyclohexyl)(meth)acrylate; vinyl alcohol, allyl alcohol and the like. Among them, as the hydroxyl group-containing monomer, hydroxyl group-containing (meth)acrylic acid ester is preferable, and 2-hydroxyethyl acrylate (HEA) and 4-hydroxybutyl acrylate (4HBA) are more preferable.

The content of the hydroxyl group-containing monomer based on the total amount (100 wt %) of monomer components forming the acrylic polymer (A) is 10 to 40 wt %, preferably 12 to 35 wt %, and further preferably 13 to 30 wt %. Since the content of the hydroxyl group-containing monomer is 10 wt % or more, the whitening of the pressure-sensitive adhesive sheet under a high-temperature and high-humidity environment can be suppressed. On the other hand, since the content of the hydroxyl group-containing monomer is 40 wt % or less, the monomer components forming the polymer are easily polymerized and thus a defect in appearance is less likely to be generated in the pressure-sensitive adhesive sheet. The defect in appearance is due to formation of a gel defect resulting from a gelated product contained in a pressure-sensitive adhesive when the pressure-sensitive adhesive sheet is formed.

Furthermore, the acrylic polymer (A) substantially does not contain a carboxyl group-containing monomer in the monomer components forming the polymer. In the present specification, the term “substantially do(es) not contain” means that active blending is not performed except for the case of unavoidable incorporation. Specifically, the content of the carboxyl group-containing monomer based on the total amount (100 wt %) of monomer components forming the acrylic polymer (A) is less than 1 wt % and preferably less than 0.1 wt %. By controlling the content of the carboxyl group-containing monomer to less than 1 wt %, the carboxyl group-containing monomer as an unreacted monomer (remaining monomer) in the acrylic polymer (A) is decreased and the corrosion of the adherend and the like is suppressed, so that excellent corrosion resistance is exhibited. When the content of the carboxyl group-containing monomer is large (for example, 1 wt % or more), the corrosive carboxyl group-containing monomer exudes from the pressure-sensitive adhesive layer and is prone to corrode the adherend and the like, causing deterioration in performance of a product. Examples of the carboxyl group-containing monomer include (meth)acrylic acid, itaconic acid, maleic acid, fumaric acid, crotonic acid, isocrotonic acid, and the like. In addition, acid anhydrides (for example, acid anhydride-containing monomers such as maleic anhydride and itaconic anhydride) of these carboxyl group-containing monomers are also included in the carboxyl group-containing monomers.

From the viewpoints of improving adhesion property to the adherend and improving cohesive force of the pressure-sensitive adhesive layer, the component forming the acrylic polymer (A) may further contain, as a monomer component, a copolymerizable monomer component such as a polar group-containing monomer except the above hydroxyl group-containing monomer and the above carboxyl group-containing monomer (in the present specification, sometimes simply referred to as a “polar group-containing monomer”), a polyfunctional monomer, other monomers (monomers other than methyl methacrylate, the above alkyl(meth)acrylate, the above hydroxyl group-containing monomer, the above polar group-containing monomer, and the above polyfunctional monomer). The copolymerizable monomer component may be used alone or in combination of two or more thereof.

As the polar group-containing monomer, examples thereof include an amide group-containing monomer such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethyl(meth)acrylamide; an amino group-containing monomer such as aminoethyl(meth)acrylate, dimethylaminoethyl(meth)acrylate and t-butylaminoethyl(meth)acrylate; an glycidyl group-containing monomer such as glycidyl(meth)acrylate and methyl glycidyl(meth)acrylate; a cyano group-containing monomer such as acrylonitrile and methacrylonitrile; a hetero ring-containing vinyl monomer such as N-vinyl-2-pyrrolidone, (meth)acryloylmorpholine, vinylpyridine, N-vinylpiperidone, vinylpyrimidine, N-vinylpiperazine, N-vinylpyrrole, N-vinylimidazole and vinyloxazole; alkoxyalkyl(meth)acrylate-based monomer such as methoxyethyl(meth)acrylate and ethoxyethyl(meth)acrylate; a sulfonate group-containing monomer such as sodium vinylsulfonate; a phosphate group-containing monomer such as 2-hydroxyethylacryloyl phosphate; an imide group-containing monomer such as cyclohexylmaleimide and isopropylmaleimide; and an isocyanate group-containing monomer such as 2-methacryloyloxyethyl isocyanate; and vinyl ester monomer such as vinyl acetate and vinyl propionate. Among them, as the polar group-containing monomer, a hetero ring-containing vinyl monomer is preferable, and N-vinyl-2-pyrrolidone is more preferable. The polar group-containing monomer may be used alone or in combination of two or more thereof.

The content of the polar group-containing monomer (particularly, content of a heterocycle-containing vinyl monomer such as N-vinyl-2-pyrrolidone) based on the total amount (100 wt %) of monomer components forming the acrylic polymer (A) is not particularly limited, but is preferably 10 to 20 wt % and more preferably 13 to 17 wt %.

As the polyfunctional monomer, examples thereof include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxyacrylate, polyester acrylate and urethane acrylate. The polyfunctional monomer may be used alone or in combination of two or more thereof.

The content of the polyfunctional monomer based on the total amount (100 wt %) of monomer components forming the acrylic polymer (A) is not particularly limited but is preferably 0 to 0.5 wt % and more preferably 0 to 0.3 wt %. When the content of the polyfunctional monomer is 0.5 wt % or less, the cohesive force does not become unduly high and the pressure-sensitive adhesion property is easily improved, so that the case is preferable. In the case where a crosslinking agent is used, the polyfunctional monomer may not be used but, in the case where the crosslinking agent is not used, the content of the polyfunctional monomer is preferably 0.001 to 0.5 wt % and more preferably from 0.002 to 0.1 wt %.

Furthermore, examples of the other monomers include (meth)acrylic acid esters having an alicyclic hydrocarbon group, such as cyclopentyl(meth)acrylate, cyclohexyl(meth)acrylate, and isobornyl(meth)acrylate; aryl(meth)acrylate such as phenyl(meth)acrylate; aromatic vinyl compounds such as styrene and vinyltoluene; olefins or diener such as ethylene, butadiene, isoprene, and isobutylene; vinyl ethers such as vinyl alkyl ethers; vinyl chloride; and the like.

The acrylic polymer (A) can be obtained by polymerizing the above monomer components by any of known and conventional polymerization methods. Examples of the polymerization methods include a solution polymerization method, an emulsion polymerization method, a bulk polymerization method, a polymerization method by an activation energy-ray irradiation (activation energy-ray polymerization method), and the like. In the polymerization, suitable components according to each polymerization method, such as a polymerization initiator, a chain-transfer agent, an emulsifier, and a solvent may be used by suitably selecting from known or conventional ones.

Among them, as the polymerization method, the solution polymerization method and the emulsion polymerization method are preferable. This is because the solution polymerization is excellent in productivity and costs and the emulsion polymerization is excellent in view of the environment.

In the case where the polymerization is performed by solution polymerization, it is preferable to use a thermal polymerization initiator as a polymerization initiator. Examples of the thermal polymerization initiator include an azo-based polymerization initiator, a peroxide-based polymerization initiator, a redox-based polymerization initiator, and the like. As the azo-based polymerization initiator, examples thereof includes 2,2′-azobisisobutyronitrile, 2,2′-azobis-2-methylbutyronitrile, dimethyl 2,2′-azobis(2-methylpropionate), 4,4′-azobis-4-cyanovalerianic acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine)dihydrochloride, and the like. Moreover, as the peroxide-based polymerization initiator, examples thereof includes t-butyl hydroperoxide, di-t-butyl peroxide, 1,1-bis(t-butylperoxy)-3,3,5-trimethylcyclohexane, 1,1-bis(t-butylperoxy)cyclododecane, dicumyl peroxide, and the like. The thermal polymerization initiator may be used alone or in combination of two or more thereof.

The used amount of the thermal initiator is not particularly limited, but is preferably 0.05 to 0.5 part by weight and more preferably 0.1 to 0.3 part by weight based on the total amount (100 wt %) of monomer components forming the acrylic polymer (A).

In the solution polymerization, various kinds of general solvents can be used. Examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

Moreover, in the case where the polymerization is performed by emulsion polymerization, known or conventional emulsion polymerization methods may be used. For example, a common en bloc charging method (en bloc polymerization method), a monomer emulsion-dropping method, and the like may be employed. In the case where a monomer emulsion is dropped, it may be continuously dropped or may be dividedly dropped. The polymerization temperature can be suitably selected depending on the kind of the polymerization initiator and the like and is, for example, in a range of 5 to 100° C.

The emulsifier to be used during the emulsion polymerization, if needed, is not particularly limited, and examples thereof include anionic emulsifiers such as sodium lauryl sulfate, ammonium lauryl sulfate, sodium dodecylbenzenesulfonate, sodium polyoxyethylene alkyl ether sulfate, ammonium polyoxyethylene alkylphenyl ether sulfate, sodium polyoxyethylene alkylphenyl ether sulfate and sodium polyoxyethylene alkyl sulfosuccinate; and nonionic emulsifier such as polyoxyethylene alkyl ether, polyoxyethylene alkylphenyl ether, polyoxyethylene fatty acid ester and polyoxyethylene-polyoxypropylene block polymer. In addition, examples thereof further include radical polymerizable emulsifier having a form (or corresponding to the form) in which a radical polymerizable functional group (radical reactive group) such as propenyl group or allyl ether group is introduced into them (emulsifier such as anionic emulsifier such as sodium lauryl sulfate, ammonium lauryl sulfate and sodium dodecylbenzenesulfonate; or nonionic emulsifier such as polyoxyethylene alkyl ether, polyoxyethylene alkylphenyl ether, polyoxyethylene fatty acid ester and polyoxyethylene-polyoxypropylene block polymer). The emulsifier can be used solely or in combination of two or more kinds thereof.

The used amount of the emulsifier is not particularly limited but is, for example, preferably 0.1 to 5 parts by weight and more preferably 0.4 to 3 parts by weight based on the total amount (100 wt %) of monomer components forming the acrylic polymer (A).

Moreover, the polymerization initiator for use in the emulsion polymerization according to need is not particularly limited, but examples thereof include an azo-based polymerization initiator, a persulfate salt-based polymerization initiator, a peroxide-based polymerization initiator, a redox-based polymerization initiator, and the like. Examples of the azo-based polymerization initiator include 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N-dimethyleneisobutylamidine)dihydrochloride, and the like. Examples of the persulfate salt-based polymerization initiator include potassium persulfate, ammonium persulfate, and the like. Examples of the peroxide-based polymerization initiator include benzoyl peroxide, t-butyl hydroperoxide, hydrogen peroxide, and the like. Examples of the redox-based polymerization initiator include redox-based initiators in which a peroxide and a reducing agent are combined, such as a combination of a persulfate salt and sodium hydrogen sulfite and a combination of a peroxide and sodium ascorbate. Such a polymerization initiator may be a water-soluble initiator or an oil-soluble initiator. Moreover, the polymerization initiator may be used alone or in combination of two or more thereof.

The used amount of the polymerization initiator is not particularly limited, but is preferably from 0.02 to 0.5 part by weight and more preferably from 0.08 to 0.3 part by weight based on the total amount (100 wt %) of monomer components forming the acrylic polymer (A).

During the solution polymerization or emulsion polymerization, a chain transfer agent can be used for the purpose of adjusting the molecular weight. The chain transfer agent is not particularly limited, and examples thereof include 1-dodecanethiol, mercaptoacetic acid, 2-mercaptoethanol, 2-ethylhexyl thioglycolate and 2,3-dimercapto-1-propanol. The chain transfer agent can be used solely or in combination of two or more kinds thereof. The used amount of the chain transfer agent is not particular limited, but for example, is preferably 0.001 to 0.5 parts by weight based on the total amount (100 parts by weight) forming the polymer.

The acrylic polymer (A) is preferably crosslinked from the viewpoint of effectively suppressing the white turbidity of the pressure-sensitive adhesive sheet under a high-temperature and high-humidity environment, from the viewpoint of strengthening the cohesive force of the pressure-sensitive adhesive sheet under a high-temperature and high-humidity environment to be less unlikely to generate foaming, from the viewpoint of the pressure-sensitive adhesive force, and from the viewpoint of coating property and fluidity of the pressure-sensitive adhesive composition. More preferably, the acrylic polymer (A) is preferably one obtained by crosslinking an acrylic polymer having a weight average molecular weight of 400,000 to 900,000. In the present specification, the acrylic polymer before crosslinking is sometimes referred to as an “acrylic polymer (B)”. Namely, in the case where the acrylic polymer (A) is crosslinked one, the acrylic polymer (A) is obtained by crosslinking the acrylic polymer (B).

The acrylic polymer (B) is preferably crosslinked by a crosslinking agent (particularly, a crosslinking agent to be mentioned below).

The composition of the monomer component forming the acrylic polymer (A) is common to the composition of the monomer component forming the acrylic polymer (B). The acrylic polymer (B) is preferably an acrylic polymer being formed from a component including, as an essential monomer component, methyl methacrylate and a hydroxyl group-containing monomer, wherein a content of the hydroxyl group-containing monomer based on a total amount (100 wt %) of the monomer component forming the acrylic polymer (B) is 10 to 40 wt %, the component forming the acrylic polymer (B) substantially does not contain a carboxyl group-containing monomer, and the weight average molecular weight is 400,000 to 900,000. Moreover, the acrylic polymer (B) is more preferably an acrylic polymer formed from a component including, as an essential monomer component, methyl methacrylate and the hydroxyl group-containing monomer, wherein the content of the hydroxyl group-containing monomer based on a total amount (100 wt %) of the monomer component forming the acrylic polymer (B) is 10 to 40 wt %, the content of the methyl methacrylate based on the total amount (100 wt %) of the monomer component forming the acrylic polymer (B) is more than 0 wt % and 30 wt % or less, the component forming the acrylic polymer (B) substantially does not contain a carboxyl group-containing monomer, and the weight average molecular weight is 400,000 to 900,000.

Moreover, the acrylic polymer (B) can be obtained by the same polymerization method as in the case of the acrylic polymer (A).

The weight average molecular weight of the acrylic polymer (B) is not particularly limited, but is preferably 400,000 to 900,000, more preferably 450,000 to 850,000, further preferably 500,000 to 800,000, and particularly preferably 550,000 to 750,000.

The weight average molecular weight of the acrylic polymer (B) can be controlled by the kind of the polymerization initiator or the amount thereof, and temperature or time in the polymerization, and also monomer concentration, a monomer-dropping rate, use of a chain-transfer agent, an amount thereof, or the like.

The weight average molecular weight (Mw) can be measured by a gel permeation chromatograph (GPC) method. Specifically, for example, the weight average molecular weight can be measured as a value in terms of polystyrene by using the measurement apparatus and the measurement conditions described below.

(Preparation of Sample for Measurement)

An acrylic polymer is dissolved in a 10 mM-LiBr+10 mM-phosphoric acid/DMF solution (eluent) to prepare a solution in which the concentration of the acrylic polymer is 2.0 g/L. After allowed to stand overnight, the solution is filtrated through a 0.45 μm membrane filter and the filtrate is used as a sample for measurement.

(Measurement Apparatus and Measurement Conditions)

Measurement apparatus: trade name “HLC-8120GPC” (manufactured by Tosoh Corporation)

Column: trade name “TSK GEL, SUPER AWM-H+SUPER AW4000+SUPER AW2500” (manufactured by Tosoh Corporation)

Column size: 6.0 mm I.D.×150 mm each

Eluent: 10 mM-LiBr+10 mM-phosphoric acid/DMF

Flow rate: 0.4 mL/min

Detector: Refractive Index (RI) detector

Column temperature (measurement temperature): 40° C.

Injection amount: 20 μL

The pressure-sensitive adhesive forming the pressure-sensitive adhesive layer of the present invention may be a pressure-sensitive adhesive having any form. For example, the pressure-sensitive adhesive may be an emulsion type pressure-sensitive adhesive, a solvent type (solution type) pressure-sensitive adhesive, an active energy ray-curable pressure-sensitive adhesive, a hot melt type pressure-sensitive adhesive, or the like. Of these, the pressure-sensitive adhesive forming the pressure-sensitive adhesive layer of the present invention is preferably a solvent-type pressure-sensitive adhesive or an emulsion-type pressure-sensitive adhesive from the viewpoint of productivity.

(Pressure-Sensitive Adhesive Composition)

As mentioned above, the pressure-sensitive adhesive layer of the present invention is preferably formed from a pressure-sensitive adhesive composition. The pressure-sensitive adhesive composition is not particularly limited, but examples thereof include an acrylic pressure-sensitive adhesive composition containing the above acrylic polymer (acrylic polymer (A) and/or acrylic polymer (B)) as an essential component, an acrylic pressure-sensitive adhesive composition containing a mixture of monomers forming the acrylic polymer (A) (referred to as a “monomer mixture” in some cases) or a partially polymerized product thereof as an essential component, and the like. Examples of the former case include a so-called solvent type pressure-sensitive adhesive composition, an emulsion type pressure-sensitive adhesive composition, and the like. Moreover, examples of the latter case include a so-called active energy ray-curable pressure-sensitive adhesive composition and the like. The pressure-sensitive adhesive composition may further contain additives according to need.

The term “monomer mixture” means a mixture consisting of monomer components forming the polymer. Moreover, the term “partially polymerized product” means a composition in which one component or two or more components among constituent components of the monomer mixture are partially polymerized.

The solvent type pressure-sensitive adhesive composition may be a solvent type pressure-sensitive adhesive composition containing an acrylic polymer obtained by a solution polymerization method and an organic solvent or may be a solvent type pressure-sensitive adhesive composition obtained by dissolving an acrylic polymer, which has been obtained by a polymerization method other than solution polymerization, into an organic solvent. Moreover, the emulsion type pressure-sensitive adhesive composition may be a water-dispersed type pressure-sensitive adhesive composition containing water and an acrylic polymer obtained by an emulsion polymerization method, or may be a water-dispersed type pressure-sensitive adhesive composition obtained by dispersing an acrylic polymer, which has been obtained by a polymerization method other than the emulsion polymerization method, into water.

The pressure-sensitive adhesive composition can be, without particular limitation, obtained by mixing, for example, the above acrylic polymer (acrylic polymer (A) and/or acrylic polymer (B)) and, if necessary, water and a solvent such as an organic solvent, additives, and the like.

The above pressure-sensitive adhesive composition (or the pressure-sensitive adhesive layer of the present invention) preferably contains a crosslinking agent for further enhancing the cohesive force of the pressure-sensitive adhesive layer of the present invention or for controlling the gel fraction of the pressure-sensitive adhesive layer.

Particularly, in addition to the above, from the viewpoint of effectively suppressing the white turbidity of the pressure-sensitive adhesive sheet under a high-temperature and high-humidity environment, from the viewpoint of strengthening the cohesive force of the pressure-sensitive adhesive sheet under a high-temperature and high-humidity environment to be less likely to generate foaming, from the viewpoint of the pressure-sensitive adhesive force, and from the viewpoint of the coating property and fluidity of the pressure-sensitive adhesive composition, the pressure-sensitive adhesive layer of the present invention is preferably formed from a pressure-sensitive adhesive composition containing at least an acrylic polymer (acrylic polymer (B)) having a weight average molecular weight of 400,000 to 900,000 (more preferably, 450,000 to 850,000, further preferably 500,000 to 800,000, and particularly preferably 550,000 to 750,000) and a crosslinking agent.

Examples of the crosslinking agent include an isocyanate-based crosslinking agent, an epoxy-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an aziridine-based crosslinking agent, an amine-based crosslinking agent, and the like. The crosslinking agent may be used alone or in combination of two or more thereof.

Of these, from the viewpoint of improving the anti-foaming release property under a high-temperature and high-humidity environment and from the viewpoint of optical properties, the crosslinking agent is preferably an isocyanate-based crosslinking agent or an epoxy-based crosslinking agent and more preferably an isocyanate-based crosslinking agent.

As the isocyanate-based crosslinking agent (polyfunctional isocyanate compound), examples thereof include lower aliphatic polyisocyanates such as 1,2-ethylene diisocyanate, 1,4-butylenediisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. The isocyanate-based crosslinking agent may be, for example, commercially available products such as a trimethylolpropane/tolylene diisocyanate adduct (manufactured by Nippon Polyurethane Industry Co., Ltd., trade name “CORONATE L”), a trimethylolpropane/hexamethylene diisocyanate adduct (manufactured by Nippon Polyurethane Industry Co., Ltd., trade name “CORONATE HL”), a trimethylolpropane/xylylene diisocyanate adduct (manufactured by Mitsui Chemicals Co., Ltd., trade name “TAKENATE D-110N”) and hexamethylene diisocyanate-based isocyanate compound (manufactured by Asahi Kasei Chemicals Corporation, trade name “DURANATE”).

As the epoxy-based crosslinking agent (polyfunctional epoxy compound), examples thereof include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-S-diglycidyl ether and an epoxy-based resin having two or more epoxy groups in the molecule. The epoxy-based crosslinking agent may be, for example, commercially available products such as trade name “TETRAD C” manufactured by Mitsubishi Gas Chemical Company, Inc.

The content of the crosslinking agent in the pressure-sensitive adhesive composition (or pressure-sensitive adhesive layer of the present invention) is not particularly limited, but is preferably 0.001 to 10 parts by weight and more preferably 0.01 to 5 parts by weight based on 100 parts by weight of the acrylic polymer. For example, in the case where the pressure-sensitive adhesive layer of the present invention is formed from a pressure-sensitive adhesive composition containing at least the acrylic polymer (B) and the crosslinking agent, the content of the crosslinking agent in the pressure-sensitive adhesive composition is not particularly limited, but is preferably 0.001 to 10 parts by weight and more preferably 0.01 to 5 parts by weight based on 100 parts by weight of the acrylic polymer (B). When the content of the crosslinking agent is 0.001 part by weight or more, the anti-foaming release property under a high-temperature and high-humidity environment is easily improved, so that the case is preferable. On the other hand, when the content of the crosslinking agent is 10 parts by weight or less, the pressure-sensitive adhesive layer has appropriate flexibility and the pressure-sensitive adhesive force is easily improved, so that the case is preferable.

The pressure-sensitive adhesive composition (or the pressure-sensitive adhesive layer of the present invention) may further include a silane coupling agent for the purpose of improving an adhesion property to glass (in particular, adhesive reliability to a glass under high temperature and high humidity environments). The silane coupling agent is not particularly limited, and examples thereof include γ-glycidoxypropyltrimethoxysilane, γ-glycidoxypropyltriethoxysilane, γ-aminopropyltrimethoxysilane and N-phenyl-aminopropyltrimethoxysilane are preferably exemplified. Among them, γ-glycidoxypropyltrimethoxysilane is preferable. As the silane coupling agent, for example, a commercially available product such as trade name “KBM-403” (manufactured by Shin-Etsu Chemical Co., Ltd.) may be used. The silane coupling agent may be used either alone or in combination of two or more thereof.

The content of the silane coupling agent in the pressure-sensitive adhesive composition (or the pressure-sensitive adhesive layer of the present invention) is preferably 0.01 to 1 part by weight and more preferably 0.03 to 0.5 part by weight based on the acrylic polymer, from the viewpoint of improving adhesive reliability to a glass under a high-temperature and high-humidity environment.

In the pressure-sensitive adhesive composition (or the pressure-sensitive adhesive layer of the present invention), if necessary, known additives such as a crosslinking accelerator, a tackifying resin (rosin derivative, polyterpene resin, petroleum resin, and oil-soluble phenol), an antiaging agent, a filler, a colorant (dye or pigment), ultraviolet absorber, an antioxidant, a plasticizer, a softener, a surfactant and an antistatic agent may be used as long as the property of the present invention is not impaired. In addition, various general solvents (for example, the solvents to be used during the above-described solution polymerization) or water may be included in the pressures-sensitive adhesive composition.

The formation of the pressure-sensitive adhesive layer is not particularly limited, but the pressure-sensitive adhesive layer can be formed by applying the pressure-sensitive adhesive composition on a substrate or a release liner, and if necessary, drying and/or curing the applied pressure-sensitive adhesive composition. In the coating of the pressure-sensitive adhesive composition, a known coating method can be used. For example, a common coater such as a gravure roll coater, a reverse roll coater, a kiss roll coater, a dip roll coater, a bar coater, a knife coater, a spray coater, a comma coater and a direct coater, can be used.

The gel fraction (ratio of solvent insoluble matter) of the pressure-sensitive adhesive layer of the present invention is 70 to 100% (wt %), preferably 75 to 95%, and more preferably 80 to 95%. The gel fraction can be measured as an insoluble matter in ethyl acetate, and in detail, as a weight fraction (unit: wt %) of an insoluble matter after the pressure-sensitive adhesive layer is immersed in ethyl acetate at 23° C. for 7 days, with respect to the sample before immersing. Since the gel fraction is 70% or more, the cohesive force of the pressure-sensitive adhesive layer is improved, foaming under a high-temperature and high-humidity environment can be suppressed, and further the adhesion property to an adherend can be improved, so that release under a high-temperature and high-humidity environment can be suppressed. Furthermore, haze can be decreased to obtain high transparency.

Specifically, the gel fraction (solvent insoluble component) is, for example, a value calculated by “Method of measuring gel fraction” to be described below.

(Method of Measuring Gel Fraction)

About 0.1 g of the pressure-sensitive adhesive layer is sampled from the pressure-sensitive adhesive sheet, wrapped with a porous tetrafluoroethylene sheet (trade name “NTF1122”, manufactured by Nitto Denko Corporation) having an average pore size of 0.2 μm, and it is tied up with a kite string and at this time, it is measured for the weight, and the weight measured is designated as the weight before immersion. The weight before immersion is the total weight of the pressure-sensitive adhesive layer (pressure-sensitive adhesive layer sampled above), the tetrafluoroethylene sheet and the kite string. The total weight of the tetrafluoroethylene sheet and the kite string is also measured, and this weight is designated as the wrapper weight.

Subsequently, the pressure-sensitive adhesive layer of the present invention wrapped with a tetrafluoroethylene sheet and tied up with a kite string (hereinafter referred to as the “sample”) is put in a 50 ml-volume vessel filled with ethyl acetate, followed by allowing to stand still at 23° C. for 7 days. The sample (after ethyl acetate treatment) is then taken out of the vessel, and it is transferred to an aluminum-made cup, followed by drying in a dryer at 130° C. for 2 hours to remove ethyl acetate, and it is measured for the weight, and this weight is designated as the weight after immersion.

The gel fraction is calculated according to the following formula:

Gel fraction(wt %)=((X−Y)/(Z−Y))×100

(wherein X is the weight after immersion, Y is the wrapper weight, and Z is the weight before immersion).

The gel fraction can be, for example, controlled by the monomer composition of the polymer or the weight average molecular weight of the polymer, the used amount (added amount) of the crosslinking agent, or the like.

The total light transmittance (in accordance with JIS K 7361-1) of the pressure-sensitive adhesive layer of the present invention is not particularly limited but is preferably 85% or more and more preferably 90% or more. The total light transmittance can be, for example, measured using a haze meter in accordance with JIS K7361-1.

The haze (in accordance with JIS K 7136) of the pressure-sensitive adhesive layer of the present invention is not particularly limited, but is preferably 5.0% or less, more preferably 3.0% or less, further preferably 2.0% or less, and particularly preferably 1.5% or less. The haze can be, for example, measured using a haze meter in accordance with JIS K7136.

The thickness of the pressure-sensitive adhesive layer of the present invention is not particularly limited, but is preferably 10 to 500 μm, more preferably 10 to 250 μm, and further preferably 10 to 100 μm. When the thickness is 10 μm or more, stress generated during lamination is prone to disperse and release is less likely to occur, so that the case is preferable. On the other hand, when the thickness is 100 μm or less, creases are less likely to be generated during winding the pressure-sensitive adhesive sheet and protrusion of the pressure-sensitive adhesive to a side surface can be suppressed, so that the case is preferable.

(Other Pressure-Sensitive Adhesive Layer)

The pressure-sensitive adhesive sheet of the present invention may include other pressure-sensitive adhesive layer (a pressure-sensitive adhesive layer other than the pressure-sensitive adhesive layer of the present invention). The other pressure-sensitive adhesive layer includes, but not limited to, a known or common pressure-sensitive adhesive layer formed from a known pressure-sensitive adhesive such as an urethane-based pressure-sensitive adhesive, acrylic pressure-sensitive adhesive, rubber-based pressure-sensitive adhesive, silicone-based pressure-sensitive adhesive, polyester-based pressure-sensitive adhesive, polyamide-based pressure-sensitive adhesive, epoxy-based pressure-sensitive adhesive, vinylalkylether-based pressure-sensitive adhesive, and fluorine-based pressure-sensitive adhesive. The pressure-sensitive adhesive may be used alone or in combination of two or more kinds thereof.

(Substrate)

The pressure-sensitive adhesive sheet of the present invention may be a pressure-sensitive adhesive sheet including a substrate (pressure-sensitive adhesive sheet with substrate). The substrate is not particularly limited, and examples thereof include various optical films such as a plastic film, an antireflection (AR) film, a polarizing plate and a retardation film. As materials of the plastic film and the like, examples thereof include plastic materials such as polyester resins such as polyethylene terephthalate (PET); acrylic resins such as polymethyl methacrylate (PMMA); polycarbonate; triacetyl cellulose (TAC); polysulfone; polyarylate; polyimide; polyvinyl chloride; polyvinyl acetate; polyethylene; polypropylene; ethylene-propylene copolymer; cyclic olefin-based polymer such as trade name “ARTON (cyclic olefin-based polymer; manufactured by JSR)” and trade name “ZEONOR (cyclic olefin-based polymer; manufactured by Nippon Zeon Co., Ltd.)”. The plastic materials may be used either alone or in combination of two or more thereof. The “substrate” is a part laminated to an adherend together with the pressure-sensitive adhesive layer, when the pressure-sensitive adhesive sheet is laminated to the adherend (an optical member and the like). The separator (release liner) released in the use (lamination) of the pressure-sensitive adhesive sheet is not included in the “substrate”.

The substrate is preferably a transparent substrate. The total light transmittance in a visible light wavelength region of the substrate (in accordance with JIS K7361-1) is not particularly limited, but is preferably 85% or more, and more preferably 90% or more. The haze of the substrate (in accordance with JIS K7136) is not particularly limited, but is preferably 2.0% or less, and more preferably 1.5% or less. The transparent substrate may be a PET film or a non-oriented film such as trade name “ARTON”, and trade name “ZEONOR”.

The thickness of the substrate is not particularly limited, but for example, is preferably 12 μm to 75 μm. The substrate may have a single layer shape or multilayer shape. On the surface of the substrate, for example, a known/general surface treatment such as a physical treatment such as a corona discharge treatment and a plasma treatment, and a chemical treatment such as an undercoat treatment, may be properly performed.

(Pressure-Sensitive Adhesive Sheet of the Present Invention)

The pressure-sensitive adhesive sheet of the present invention may have at least one layer of the pressure-sensitive adhesive layer of the present invention. The pressure-sensitive adhesive sheet is not particularly limited but may be a double-sided pressure-sensitive adhesive sheet in which both surfaces thereof are a pressure-sensitive adhesive surface, or may be a single-sided pressure-sensitive adhesive sheet in which only one surface thereof is a pressure-sensitive adhesive surface. Of these, the pressure-sensitive adhesive sheet of the present invention is preferably the double-sided pressure-sensitive adhesive sheet from the viewpoint of laminating two members each other.

Moreover, the pressure-sensitive adhesive sheet of the present invention may be a so-called substrateless pressure-sensitive adhesive sheet having no substrate (substrate layer) or may be a pressure-sensitive adhesive sheet having a substrate (pressure-sensitive adhesive sheet with a substrate).

When the pressure-sensitive adhesive sheet of the present invention is a substrateless pressure-sensitive adhesive sheet, examples of the specific structure include, for example, a double-sided pressure-sensitive adhesive sheet consisting of the pressure-sensitive adhesive layer of the present invention and a double-sided pressure-sensitive adhesive sheet including the pressure-sensitive adhesive layer of the present invention and the other pressure-sensitive adhesive layer (a pressure-sensitive adhesive layer other than the pressure-sensitive adhesive layer of the present invention). When the pressure-sensitive adhesive sheet of the present invention is a pressure-sensitive adhesive sheet with a substrate, examples of the specific structure include a single-sided pressure-sensitive adhesive sheet including the pressure-sensitive adhesive layer of the present invention on one side of the substrate, a double-sided pressure-sensitive adhesive sheet including the pressure-sensitive adhesive layers of the present invention on both sides of the substrate, and a double-sided pressure-sensitive adhesive sheet including the pressure-sensitive adhesive layer of the present invention on one side of the substrate and the other pressure-sensitive adhesive layer on the other side of the substrate.

Among them, the pressure-sensitive adhesive sheet of the present invention is preferably the substrateless pressure-sensitive adhesive sheet since it can be used for lamination to a variety of adherends, members, or the like without limiting the kind of adherend, member, or the like, and the double-sided pressure-sensitive adhesive sheet consisting of only the pressure-sensitive adhesive layer of the present invention is more preferable.

The pressure-sensitive adhesive sheet of the present invention may have other layers (for example, an intermediate layer, an undercoat layer, and the like) other than the pressure-sensitive adhesive layer of the present invention, the other pressure-sensitive adhesive layer, and the substrate, within a range where the effect of the present invention is not impaired.

On the pressure-sensitive adhesive surface of the pressure-sensitive adhesive sheet of the present invention, the separator (release liner) may be provided until it is used. In the case where the pressure-sensitive adhesive sheet of the present invention is a double-sided pressure-sensitive adhesive sheet, each pressure-sensitive adhesive surface may be protected by using separators, respectively, or protected in such a way that the surface is wound in a roll form by using one separator of which both sides are release surfaces. The separator is used as a protective material of the pressure-sensitive adhesive layer, and peeled when the pressure-sensitive adhesive layer is laminated to the adherend. In the case where the pressure-sensitive adhesive sheet of the present invention is a substrateless pressure-sensitive adhesive sheet, the separator functions as a support of the pressure-sensitive adhesive layer. The separator may not be provided. As the separator, any known release paper may be used. The separator may be, but not particularly limited to, for example, a substrate having a release treated layer, a low adhesive substrate composed of a fluorine polymer, or a low adhesive substrate composed of a non-polar polymer. As the substrate having the release treated layer, examples thereof include a plastic film or paper whose surface is treated by a release agent such as silicon type, long-chain alkyl type, fluorine type, and molybdenum sulfide. As the fluorine-based polymer in the low adhesive substrate composed of fluorine polymer, examples thereof include polytetrafluoroethylene, polychlorotrifluoroethylene, polyvinyl fluoride, polyvinylidene fluoride, a tetrafluoroethylene-hexafluoropropylene copolymer and a chlorofluoroethylene-vinylidene fluoride copolymer. As the non-polar polymer, examples thereof include an olefine-based resin (for example, polyethylene, polypropylene and the like). The separator can be formed by using a known/general method. The thickness of the separator is not particularly limited.

The thickness (total thickness) of the pressure-sensitive adhesive sheet of the present invention is not particularly limited, but is preferably 10 to 500 μm and more preferably 10 to 250 μm. When the thickness is 10 μm or more, the pressure-sensitive adhesive sheet having no uneven thickness is easily manufactured and it is advantageous in view of easiness of exhibiting tape properties such as pressure-sensitive adhesive force and anti-foaming property, so that the case is preferable. On the other hand, when the thickness is 500 μM or less, it is advantageous in view of processability and productivity, so that the case is preferable. The thickness of the separator is not included in the thickness of the pressure-sensitive adhesive sheet of the present invention.

The total light transmittance (total light transmittance in a visible light wavelength region, in accordance with JIS K 7361-1) of the pressure-sensitive adhesive sheet of the present invention is not particularly limited, but is preferably 85% or more and more preferably 90% or more. When the total light transmittance of the pressure-sensitive adhesive sheet is 85% or more, transparency and appearance of optical members and optical products containing the pressure-sensitive adhesive sheet laminated thereto can be improved, so that the case is preferable. The total light transmittance can be, for example, measured using a haze meter in accordance with JIS K7361-1.

The haze (in accordance with JIS K 7136) of the pressure-sensitive adhesive sheet of the present invention is not particularly limited, but is preferably 5.0% or less, more preferably 3.0% or less, further preferably 2.0% or less, and particularly preferably 1.5% or less. When the haze of the pressure-sensitive adhesive sheet is 2.0% or less, transparency and appearance of optical members and optical products containing the pressure-sensitive adhesive sheet laminated thereto can be improved, so that the case is preferable. The haze can be, for example, measured using a haze meter in accordance with JIS K7136.

The pressure-sensitive adhesive sheet of the present invention can be manufactured by a known and general manufacturing method of the pressure-sensitive adhesive sheet. For example, in the case where the pressure-sensitive adhesive sheet of the present invention is a substrateless pressure-sensitive adhesive sheet, the pressure-sensitive adhesive sheet is obtained by forming the pressure-sensitive adhesive layer of the present invention on the separator by the aforementioned method. In the case where the pressure-sensitive adhesive sheet of the present invention includes a substrate, the pressure-sensitive adhesive layer of the present invention may be directly formed on the surface of the substrate (direct scan method), or may also be formed on the substrate by forming the pressure-sensitive adhesive layer of the present invention on the separator and then transferring (laminating) the formed pressure-sensitive adhesive layer to the substrate (transfer method).

Since the pressure-sensitive adhesive sheet of the present invention has the pressure-sensitive adhesive layer of the present invention, the pressure-sensitive adhesive sheet is excellent in anti-white turbidity under a high-temperature and high-humidity environment, anti-foaming release property under a high-temperature and high-humidity environment, and further corrosive resistance. Therefore, in the case where an optical member is laminated using the pressure-sensitive adhesive sheet of the present invention, since foaming and release are less likely to be generated under a high-temperature and high-humidity environment and further whitening (white turbidity) is less likely to be generated even under a high-temperature and high-humidity environment, even when the optical member and a product (optical product) manufactured using the member are placed under a high-temperature and high-humidity environment, the appearance and the visibility of a display part and the like thereof are not adversely affected. Moreover, the pressure-sensitive adhesive sheet of the present invention is less likely to generate corrosion of the adherend, so that the appearance and the visibility of the display part and the like are not adversely affected even when the optical member is laminated using the pressure-sensitive adhesive sheet of the present invention.

Therefore, the pressure-sensitive adhesive sheet of the present invention can be suitably used in optical applications. That is, the pressure-sensitive adhesive sheet of the present invention may be an optical pressure-sensitive adhesive sheet for use in optical uses. More specifically, the pressure-sensitive adhesive sheet of the present invention may be an optical pressure-sensitive adhesive sheet for use in an application for laminating optical members each other (for optical member lamination), an application for manufacturing a product (optical product) in which the optical member is used.

The optical member refers to a member having an optical characteristic (for example, a polarized property, a photorefractive property, a light scattering property, a light reflective property, a light transmitting property, a light absorbing property, a light diffractive property, an optical rotation property and visibility). The optical member is not particularly limited so long as the optical member is a member having the optical characteristic, and a member constituting the device such as display device (image display device) and input device, or a member used in the device are exemplified, and examples thereof include a polarizing plate, a wave plate, a retardation plate, an optical compensation film, a brightness enhancing film, a light guide plate, a reflective film, an anti-reflective film, a transparent conductive film (e.g. ITO film), a design film, a decoration film, a surface protective film, a prism, lens, a color filter, a transparent substrate, and a member in which these are laminated (collectively referred to as “a functional film” in some cases). Each of the “plate” and the “film” include a plate shape, a film shape, and a sheet shape, and for example, the “polarizing film” includes a “polarizing plate” and a “polarizing sheet”.

Examples of the display device include a liquid crystal display device, an organic EL (electroluminescence) display device, a PDP (plasma display device), electronic paper, and the like. Examples of the input device include a touch panel and the like.

The optical member is not particularly limited, but, for example, may be a member composed of glass, acrylic resin, polycarbonate, polyethylene terephthalate, a metal thin film, or the like (for example, a sheet shape, film shape, or plate shape of member). As described above, the “optical member” of the present invention also includes a member (a design film, a decoration film, a surface protective film or the like) for decoration or protection while maintaining visibility of the display device or the input device as an adherend.

The embodiment of laminating optical members with the pressure-sensitive adhesive sheet of the present invention is not particularly limited but, for example, may be (1) an embodiment of laminating optical members through the pressure-sensitive adhesive sheet of the present invention or (2) an embodiment of laminating an optical member to a member other than an optical member through the pressure-sensitive adhesive sheet of the present invention, or may be (3) an embodiment of laminating the pressure-sensitive adhesive sheet of the present invention containing an optical member to an optical member or a member other than an optical member. In the embodiment of the above (3), the pressure-sensitive adhesive sheet of the present invention is preferably a double-sided pressure-sensitive adhesive sheet in which the substrate is an optical member (for example, an optical film or the like).

In the case where the pressure-sensitive adhesive sheet of the present invention is a pressure-sensitive adhesive sheet with a substrate and the above functional film is used as the substrate, the pressure-sensitive adhesive sheet of the present invention can be also used as a “pressure-sensitive adhesive functional film” having the pressure-sensitive adhesive layer of the present invention on at least one side of the functional film.

### EXAMPLES

The present invention will be described in detail below with reference to examples, but the present invention is not limited to these examples.

### Example 1

Into a separable flask, 42 parts by weight of butyl acrylate (BA), 13 parts by weight of ethyl acrylate (EA), 15 parts by weight of methyl methacrylate (MMA) and 30 parts by weight of 4-hydroxybutyl acrylate (4HBA) as monomer components, and 175 parts by weight of ethyl acetate as a polymerization solvent were added and the mixture was stirred while introducing nitrogen gas for 1 hour. After thus removing oxygen within the polymerization system, 0.2 part by weight of 2,2′-azobisisobutyronitrile was added as a polymerization initiator, and the temperature was elevated to 65° C. to allow the system to react for 5 hours. Then, the temperature was elevated to 70° C. to allow the system to react for 2 hours. Thereafter, ethyl acetate was added to provide an acrylic polymer solution having a solid concentration of 30 wt %. The acrylic polymer in the acrylic polymer solution had a weight average molecular weight of 700,000.

Next, to the above acrylic polymer solution, 0.3 part by weight of a crosslinking agent (isocyanate-based crosslinking agent, trade name “TAKENATE D110N”, manufactured by Mitsui Chemicals Inc.) based on 100 parts by weight of the acrylic polymer was added and the whole was mixed to provide an acrylic pressure-sensitive adhesive composition.

Then, the acrylic pressure-sensitive adhesive composition was applied on a release-treated surface of a polyethylene terephthalate separator (PET separator) whose surface had been release-treated (trade name “MRF75”, manufactured by Mitsubishi Plastics, Inc.) so that the thickness after drying became 25 μm, followed by heating and drying at 135° C. for 2 minutes, and it was further subjected to aging at 23° C. for 120 minutes to provide a pressure-sensitive adhesive sheet (a substrateless pressure-sensitive adhesive sheet having a structure of acrylic pressure-sensitive adhesive layer/release film).

### Example 2

A pressure-sensitive adhesive sheet (a substrateless pressure-sensitive adhesive sheet having a structure of acrylic pressure-sensitive adhesive layer/release film) was obtained in the same manner as in Example 1 except that the amount of the crosslinking agent was changed to 0.5 part by weight.

### Example 3

A pressure-sensitive adhesive sheet (a substrateless pressure-sensitive adhesive sheet having a structure of acrylic pressure-sensitive adhesive layer/release film) was obtained in the same manner as in Example 1 except that the amount of the crosslinking agent was changed to 0.8 part by weight.

### Example 4

Into a separable flask, 63 parts by weight of 2-ethylhexyl acrylate (2EHA), 15 parts by weight of N-vinylpyrrolidone (NVP), 9 parts by weight of methyl methacrylate (MMA) and 13 parts by weight of hydroxyethyl acrylate (HEA) as monomer components, and 175 parts by weight of ethyl acetate as a polymerization solvent were added and the mixture was stirred while introducing nitrogen gas for 1 hour. After thus removing oxygen within the polymerization system, 0.2 part by weight of 2,2′-azobisisobutyronitrile was added as a polymerization initiator, and the temperature was elevated to 65° C. to allow the system to react for 5 hours. Then, the temperature was elevated to 70° C. to allow the system to react for 2 hours. Thereafter, ethyl acetate was added to provide an acrylic polymer solution having a solid concentration of 30 wt %. The acrylic polymer in the acrylic polymer solution had a weight average molecular weight of 750,000.

Next, to the above acrylic polymer solution, 0.5 part by weight of a crosslinking agent (isocyanate-based crosslinking agent, trade name “DURANATE 21S-75E”, manufactured by Asahi Kasei Chemicals Corporation) based on 100 parts by weight of the acrylic polymer was added and the whole was mixed to provide an acrylic pressure-sensitive adhesive composition.

Using the acrylic pressure-sensitive adhesive composition, a pressure-sensitive adhesive sheet (a substrateless pressure-sensitive adhesive sheet having a structure of acrylic pressure-sensitive adhesive layer/release film) was obtained in the same manner as in Example 1.

### Example 5

A pressure-sensitive adhesive sheet (a substrateless pressure-sensitive adhesive sheet having a structure of acrylic pressure-sensitive adhesive layer/release film) was obtained in the same manner as in Example 4 except that the crosslinking agent was changed to 0.3 part by weight of a crosslinking agent (isocyanate-based crosslinking agent, trade name “DURANATE T4330-75B”, manufactured by Asahi Kasei Chemicals Corporation).

### Example 6

A pressure-sensitive adhesive sheet (a substrateless pressure-sensitive adhesive sheet having a structure of acrylic pressure-sensitive adhesive layer/release film) was obtained in the same manner as in Example 5 except that the amount of the crosslinking agent was changed to 0.5 part by weight.

### Example 7

Into a separable flask, 55 parts by weight of butyl acrylate (BA), 10 parts by weight of ethyl acrylate (EA), 15 parts by weight of methyl methacrylate (MMA) and 20 parts by weight of hydroxyethyl acrylate (HEA) as monomer components, and 175 parts by weight of ethyl acetate as a polymerization solvent were added and the mixture was stirred while introducing nitrogen gas for 1 hour. After thus removing oxygen within the polymerization system, 0.2 part by weight of 2,2′-azobisisobutyronitrile was added as a polymerization initiator, and the temperature was elevated to 65° C. to allow the system to react for 5 hours. Then, the temperature was elevated to 70° C. to allow the system to react for 2 hours. Thereafter, ethyl acetate was added to provide an acrylic polymer solution having a solid concentration of 30 wt %. The acrylic polymer in the acrylic polymer solution had a weight average molecular weight of 760,000.

Next, to the above acrylic polymer solution, 0.3 part by weight of a crosslinking agent (isocyanate-based crosslinking agent, trade name “TAKENATE D110N”, manufactured by Mitsui Chemicals Inc.) based on 100 parts by weight of the acrylic polymer was added and the whole was mixed to provide an acrylic pressure-sensitive adhesive composition.

Using the acrylic pressure-sensitive adhesive composition, a pressure-sensitive adhesive sheet (a substrateless pressure-sensitive adhesive sheet having a structure of acrylic pressure-sensitive adhesive layer/release film) was obtained in the same manner as in Example 1.

### Example 8

A pressure-sensitive adhesive sheet (a substrateless pressure-sensitive adhesive sheet having a structure of acrylic pressure-sensitive adhesive layer/release film) was obtained in the same manner as in Example 7 except that the amount of the crosslinking agent was changed to 0.5 part by weight.

### Comparative Example 1

Into a separable flask, 93 parts by weight of butyl acrylate (BA), 7 parts by weight of acrylic acid (AA) and 0.05 part by weight of 4-hydroxybutyl acrylate (4HBA) as monomer components, and 175 parts by weight of ethyl acetate as a polymerization solvent were added and the mixture was stirred while introducing nitrogen gas for 1 hour. After thus removing oxygen within the polymerization system, 0.2 part by weight of 2,2′-azobisisobutyronitrile was added as a polymerization initiator, and the temperature was elevated to 63° C. to allow the system to react for 10 hours. Thereafter, ethyl acetate was added to provide an acrylic polymer solution having a solid concentration of 30 wt %. The acrylic polymer in the acrylic polymer solution had a weight average molecular weight of 800,000.

Next, to the above acrylic polymer solution, 0.10 part by weight of a crosslinking agent (epoxy-based crosslinking agent, trade name “TETRAD-C”, manufactured by Mitsubishi Gas Chemical Company, Inc.) based on 100 parts by weight of the acrylic polymer was added and the whole was mixed to provide an acrylic pressure-sensitive adhesive composition.

Using the acrylic pressure-sensitive adhesive composition, a pressure-sensitive adhesive sheet (a substrateless pressure-sensitive adhesive sheet having a structure of acrylic pressure-sensitive adhesive layer/release film) was obtained in the same manner as in Example 1.

### Comparative Example 2

A pressure-sensitive adhesive sheet (a substrateless pressure-sensitive adhesive sheet having a structure of acrylic pressure-sensitive adhesive layer/release film) was obtained in the same manner as in Comparative Example 1 except that the amount of the crosslinking agent was changed to 0.15 part by weight.

### Comparative Example 3

A pressure-sensitive adhesive sheet (a substrateless pressure-sensitive adhesive sheet having a structure of acrylic pressure-sensitive adhesive layer/release film) was obtained in the same manner as in Example 7 except that the amount of the crosslinking agent was changed to 0.1 part by weight.

### Comparative Example 4

Into a separable flask, 85 parts by weight of 2-ethylhexyl acrylate (2EHA) and 15 parts by weight of acrylic acid (AA) as monomer components, and 175 parts by weight of ethyl acetate as a polymerization solvent were added and the mixture was stirred while introducing nitrogen gas for 1 hour. After thus removing oxygen within the polymerization system, 0.2 part by weight of 2,2′-azobisisobutyronitrile was added as a polymerization initiator, and the temperature was elevated to 63° C. to allow the system to react for 10 hours. Thereafter, ethyl acetate was added to provide an acrylic polymer solution having a solid concentration of 30 wt %. The acrylic polymer in the above acrylic polymer solution had a weight average molecular weight of 900,000.

Next, to the above acrylic polymer solution, 0.13 part by weight of a crosslinking agent (isocyanate-based crosslinking agent, trade name “TAKENATE D110N”, manufactured by Mitsui Chemicals Inc.) based on 100 parts by weight of the acrylic polymer was added and the whole was mixed to provide an acrylic pressure-sensitive adhesive composition.

Using the acrylic pressure-sensitive adhesive composition, a pressure-sensitive adhesive sheet (a substrateless pressure-sensitive adhesive sheet having a structure of acrylic pressure-sensitive adhesive layer/release film) was obtained in the same manner as in Example 1.

(Evaluation)

The following measurement and evaluation were performed for the double-sided pressure-sensitive adhesive sheets obtained in Examples and Comparative Examples.

(1) Gel Fraction

The gel fraction (wt %) of pressure-sensitive adhesive layer of the pressure-sensitive adhesive sheet was determined by the method described above (Method of measuring gel fraction).

(2) Total Light Transmittance

The pressure-sensitive adhesive layer surface of the pressure-sensitive adhesive sheet was laminated to a slide glass (trade name “MICRO SLIDE GLASS”, model “S”, manufactured by Matsunami Glass Ind., Ltd., thickness: 1.3 mm, total light transmittance: 91.8%, haze: 0.1%, ground edges), and allowed to stand under an environment of a temperature of 23° C. and humidity of 50% RH for 30 minutes. After that, the release film was removed to provide a test piece.

The light transmittance at respective wavelengths of the test piece was measured using a haze meter (trade name “HM-150”, manufactured by Murakami Color Research Laboratory) under an environment of 23° C. and 50% RH.

The measurement of the light transmittance was performed in accordance with JIS K7361-1.

(3) Haze

The pressure-sensitive adhesive layer surface of the pressure-sensitive adhesive sheet was laminated to a slide glass (trade name “MICRO SLIDE GLASS”, model “S”, manufactured by Matsunami Glass Ind., Ltd., thickness: 1.3 mm, total light transmittance: 91.8%, haze: 0.1%, ground edges), and allowed to stand under an environment of a temperature of 23° C. and humidity of 50% RH for 30 minutes. After that, the release film was removed to provide a test piece.

The haze of the test piece was measured using a haze meter (trade name “HM-150”, manufactured by Murakami Color Research Laboratory) under an environment of 23° C. and 50% RH.

The measurement of the haze was performed in accordance with JIS K7136.

(4) Anti-White Turbidity

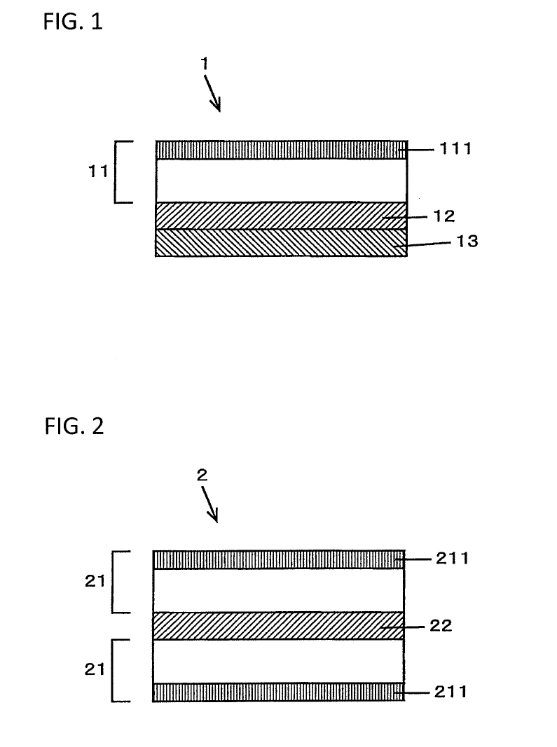

A transparent conductive film 11 (a film having a layer structure of HC (clear hard coat layer)/PET layer (PET substrate layer)/ITO layer 111) was laminated to one pressure-sensitive adhesive surface of the pressure-sensitive adhesive sheet 12 so as to come into contact with the HC surface (clear hard coat surface). Then, the resulting laminated structure (having a layer structure of “pressure-sensitive adhesive sheet 12 (pressure-sensitive adhesive layer)/transparent conductive film 11”) was allowed to stand under an environment of a temperature of 140° C. for 90 minutes to crystallize ITO. Thereafter, the other pressure-sensitive adhesive surface of the laminated structure was laminated to a glass 13 (trade name “MICRO SLIDE GLASS”, model “S-1111”, manufactured by Matsunami Glass Ind.) to provide a test piece 1. A schematic cross-sectional view of the test piece 1 is shown in FIG. 1.

The haze of the test piece was measured using a haze meter (trade name “HM-150”, manufactured by Murakami Color Research Laboratory) under an environment of 23° C. and 50% RH. It was confirmed that the haze (initial haze) was 2.0% or less.

Next, after the test piece was stored under an environment of 60° C. and 95% RH (heat and humidity environment) for 500 hours, it was taken out under an environment of 23° C. and 50% RH and the haze of the test piece immediately after taken-out was measured in the same manner as described above.

The haze was evaluated according to the following criteria.

Case where haze of the test piece immediately after taken-out is less than 2.0%: very good (anti-white turbidity is extremely good)

Case where haze of the test piece immediately after taken-out is 2.0% or more and less than 5.0%: good (anti-white turbidity is good)

Case where haze of the test piece immediately after taken-out is 5.0% or more: poor (anti-white turbidity is poor)

(5) Anti-Foaming Release Property (Anti-Foaming Property and Anti-Release Property)

Polycarbonate with ITO 21 (a polycarbonate film having a thickness of 0.15 mm, having an ITO layer 211 on one surface, and having a clear hard coat surface (HC surface) on the other surface) was laminated to one pressure-sensitive adhesive surface of the pressure-sensitive adhesive sheet 22 so as to come into contact with the HC surface. In addition, the polycarbonate with ITO 21 was similarly laminated to the other pressure-sensitive adhesive surface of the pressure-sensitive adhesive sheet 22 so as to come into contact with the HC surface. Then, the resulting laminated structure (having a layer structure of “polycarbonate with ITO 21/pressure-sensitive adhesive sheet 22 (pressure-sensitive adhesive layer)/polycarbonate with ITO 21”) was allowed to stand under an environment of a temperature of 50° C. for 1 day to thoroughly adapt it to the environment, thereby providing a test piece 2. A schematic cross-sectional view of the test piece 2 is shown in FIG. 2.

Next, after the test piece was stored under an environment of 60° C. and 95% RH (heat and humidity environment) for 500 hours, an adhesive interface between the pressure-sensitive adhesive layer and the polycarbonate plate and the adhesive interface between the pressure-sensitive adhesive layer and the transparent conductive film were visually observed to determine the presence or absence of foaming and release.

With regard to foaming (anti-foaming property), the case where foaming was not generated or an average diameter of generated foams was less than 1 mm was rated as good (good anti-foaming property) and the case where the average diameter of generated foams was 1 mm or more was rated as poor (poor anti-foaming property).

Moreover, with regard to release (anti-release property), the case where release was not generated was rated as good (good anti-release property) and the case where release was generated was rated as poor (poor anti-release property).

The results are shown in the columns of “Anti-foaming property” and “Anti-release property” of Table 1.

(6) Corrosion Resistance (Reliability)

A PET film 31a (trade name “LUMIRROR S-10 #25”, manufactured by Toray Industries, Inc., thickness: 25 μm) was laminated to one pressure-sensitive adhesive surface of the pressure-sensitive adhesive sheet 31b and was cut to a size of 20 mm in width and 50 mm in length to provide a test piece (test piece 31).

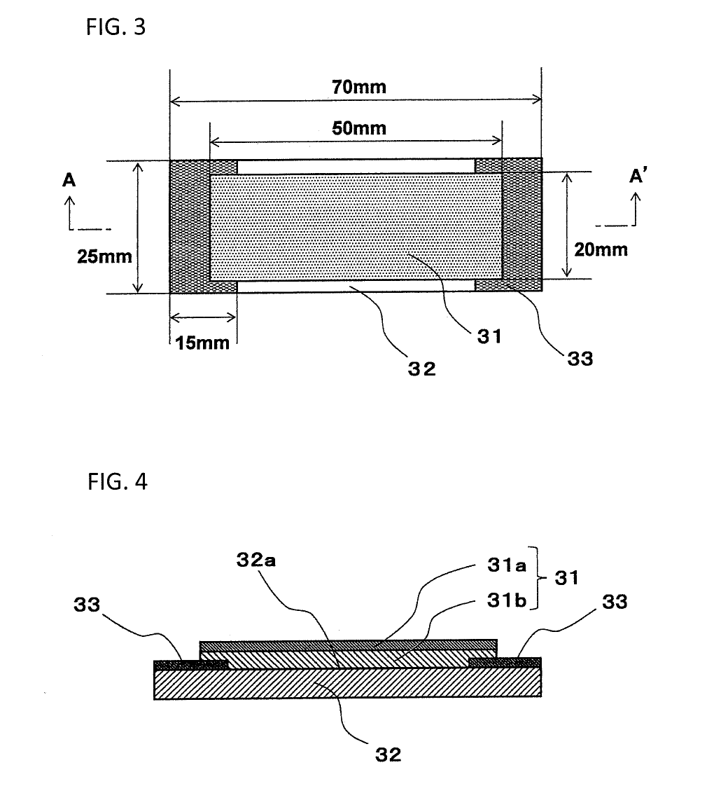

As shown in FIGS. 3 and 4, silver paste 33 was applied to both edge parts of an ITO film-formed surface 32a of a conductive PET film 32 (trade name “ELECRYSTA V-270 TFMP”, manufactured by Nitto Denko Corporation) (size: 70 mm in length and 25 mm in width) in a width of 15 mm, and the pressure-sensitive adhesive surface of the above test piece 31 was laminated on the ITO film-formed surface 32a side to provide a laminate (a laminate of test piece 31 and conductive PET film 32) (a sample for measuring resistance value). After the laminate was allowed to stand under an environment of 23° C. for 24 hours, the resistance value was measured, which was taken as a “resistance value immediately after lamination”. Then, the laminate was allowed to stand under an environment of 60° C. and 95% RH (under a heat and humidity environment) for 500 hours, the resistance value was measured, which was taken as a “resistance value after heat and humidity”.

The resistance value was measured using “3540 MILLIOHM HITESTER” manufactured by Hioki E.E. Corporation, with attaching electrodes to the surfaces of the silver paste 33 at both ends of the laminate.

Using the “resistance value immediately after lamination” and the “resistance value after heat and humidity” measured as mentioned above, a resistance value change rate was calculated according to the following equation.

“Resistance value change rate”(%)=100×(“resistance value after heat and humidity”−“resistance value immediately after lamination”)/“resistance value immediately after lamination”

The case where the resistance value change rate was less than 110% was judged to be good (good corrosion resistance (reliability) where an increase in resistance value is small) and the case where the rate is 110% or more was judged to be poor (poor corrosion resistance (reliability) where an increase in resistance value is large).

The results are shown in the column of “Corrosion resistance” of Table 1.

TABLE 1

| | | | | | | | | Anti-foaming | | |
|---|---|---|---|---|---|---|---|---|---|---|
| | | Crosslinking agent | | | | | | release property | | |
| | | | Amount | Gel | Total light | | Anti- | Anti- | Anti- | |
| | Polymer composition | | [part by | fraction | transmittance | Haze | white | foaming | release | Corrosive |
| | [weight ratio] | Kind | weight] | [wt %] | [%] | [%] | turbidity | property | property | resistance |
| Example 1 | BA/EA/MMA/4HBA = | TAKENATE | 0.30 | 84.7 | 91.4 | 1.6 | very | good | good | good |
| | 42/13/15/30 | D110N | | | | | good | | | |
| Example 2 | BA/EA/MMA/4HBA = | TAKENATE | 0.50 | 90.5 | 92.1 | 1.1 | very | good | good | good |
| | 42/13/15/30 | D110N | | | | | good | | | |
| Example 3 | BA/EA/MMA/4HBA = | TAKENATE | 0.80 | 94.9 | 92.2 | 1.0 | very | good | good | good |
| | 42/13/15/30 | D110N | | | | | good | | | |
| Example 4 | 2EHA/NVP/MMA/HEA = | DURANATE | 0.50 | 83.4 | 89.4 | 4.4 | good | good | good | good |
| | 63/15/9/13 | 21S-75E | | | | | | | | |
| Example 5 | 2EHA/NVP/MMA/HEA = | DURANATE | 0.30 | 84.0 | 90.0 | 4.3 | good | good | good | good |
| | 63/15/9/13 | T4330-75B | | | | | | | | |
| Example 6 | 2EHA/NVP/MMA/HEA = | DURANATE | 0.50 | 90.6 | 90.3 | 2.7 | good | good | good | good |
| | 63/15/9/13 | T4330-75B | | | | | | | | |
| Example 7 | BA/EA/MMA/HEA = | TAKENATE | 0.30 | 82.1 | 89.4 | 3.3 | good | good | good | good |
| | 55/10/15/20 | D110N | | | | | | | | |
| Example 8 | BA/EA/MMA/HEA = | TAKENATE | 0.50 | 89.2 | 89.2 | 2.6 | good | good | good | good |
| | 55/10/15/20 | D110N | | | | | | | | |
| Comparative | BA/AA/4HBA = | TETRAD C | 0.10 | 86.4 | 91.5 | 1.5 | very | good | good | poor |
| Example 1 | 93/7/0.05 | | | | | | good | | | |
| Comparative | BA/AA/4HBA = | TETRAD C | 0.15 | 89.9 | 92.2 | 1.0 | very | good | good | poor |
| Example 2 | 93/7/0.05 | | | | | | good | | | |
| Comparative | BA/EA/MMA/HEA = | TAKENATE | 0.10 | 57.9 | 88.0 | 9.7 | poor | good | good | good |
| Example 3 | 55/10/15/20 | D110N | | | | | | | | |
| Comparative | 2EHA/AA = | TAKENATE | 0.13 | 39.0 | 88.2 | 10.3 | poor | poor | poor | poor |
| Example 4 | 85/15 | D110N | | | | | | | | |

The abbreviations in Table 1 mean the following.
BA: n-butyl acrylate
EA: ethyl acrylate
MMA: methyl methacrylate
4HBA: 4-hydroxybutyl acrylate
2EHA: 2-ethylhexyl acrylate
NVP: N-vinylpyrrolidone
HEA: 2-hydroxyethyl acrylate
AA: acrylic acid
TAKENATE D110N: an isocyanate-based crosslinking agent (trade name “TAKENATE D110N”, manufactured by Mitsui Chemicals Inc.)
DURANATE 21S-75E: an isocyanate-based crosslinking agent (trade name “DURANATE 21S-75E”, manufactured by Asahi Kasei Chemicals Corporation)
DURANATE T4330-75B: an isocyanate-based crosslinking agent (trade name “DURANATE T4330-75B”, manufactured by Asahi Kasei Chemicals Corporation)
TETRAD C: an epoxy-based crosslinking agent (trade name “TETRAD-C”, manufactured by Mitsubishi Gas Chemical Company, Inc.)

While the invention has been described in detail and with reference to specific embodiments thereof, it will be apparent to one skilled in the art that various changes and modifications can be made therein without departing from the spirit and scope thereof.

This application is based on Japanese Patent Application No. 2011-249461 filed on Nov. 15, 2011, the entire subject matter of which is incorporated herein by reference.

The present invention provides the following pressure-sensitive adhesive sheet.

(1) A pressure-sensitive adhesive sheet comprising a pressure-sensitive adhesive layer, wherein

the pressure-sensitive adhesive layer comprises an acrylic polymer (A),

the acrylic polymer (A) is formed from a component comprising, as an essential monomer component, methyl methacrylate and a hydroxyl group-containing monomer,

a content of the hydroxyl group-containing monomer based on a total amount (100 wt %) of the monomer component forming the acrylic polymer (A) is 10 to 40 wt %,

the component forming the acrylic polymer (A) substantially does not contain a carboxyl group-containing monomer, and

a gel fraction of the pressure-sensitive adhesive layer is 70 to 100 wt %.

(2) The pressure-sensitive adhesive sheet according to (1), wherein the acrylic polymer (A) is obtained by crosslinking an acrylic polymer (B) having a weight average molecular weight of 400,000 to 900,000.

(3) The pressure-sensitive adhesive sheet according to (1) or (2), wherein a content of the methyl methacrylate based on the total amount (100 wt %) of the monomer component forming the acrylic polymer (A) is more than 0 wt % and 30 wt % or less.

(4) The pressure-sensitive adhesive sheet according to any one of (1) to (3), which is an optical pressure-sensitive adhesive sheet.

### DESCRIPTION OF REFERENCE NUMERALS AND SIGNS

1 Test piece
11 Transparent conductive film
111 ITO layer
12 Pressure-sensitive adhesive sheet
13 Glass
2 Test piece
21 Polycarbonate with ITO
211 ITO layer
22 Pressure-sensitive adhesive sheet
31 Test piece
31a PET film
31b Pressure-sensitive adhesive sheet
32 Conductive PET film
32a ITO film-formed surface
33 Silver paste

What is claimed is:

1. A pressure-sensitive adhesive sheet comprising a pressure-sensitive adhesive layer, wherein
the pressure-sensitive adhesive layer comprises an acrylic polymer (A),
the acrylic polymer (A) is formed from a component comprising, as an essential monomer component, methyl methacrylate and a hydroxyl group-containing monomer,
a content of the hydroxyl group-containing monomer based on a total amount (100 wt %) of the monomer component forming the acrylic polymer (A) is 10 to 40 wt %,
the component forming the acrylic polymer (A) substantially does not contain a carboxyl group-containing monomer, and
a gel fraction of the pressure-sensitive adhesive layer is 70 to 100 wt %.

2. The pressure-sensitive adhesive sheet according to claim 1, wherein the acrylic polymer (A) is obtained by crosslinking an acrylic polymer (B) having a weight average molecular weight of 400,000 to 900,000.

3. The pressure-sensitive adhesive sheet according to claim 1, wherein a content of the methyl methacrylate based on the total amount (100 wt %) of the monomer component forming the acrylic polymer (A) is more than 0 wt % and 30 wt % or less.

4. The pressure-sensitive adhesive sheet according to claim 2, wherein a content of the methyl methacrylate based on the total amount (100 wt %) of the monomer component forming the acrylic polymer (A) is more than 0 wt % and 30 wt % or less.

5. The pressure-sensitive adhesive sheet according to claim 1, which is an optical pressure-sensitive adhesive sheet.

6. The pressure-sensitive adhesive sheet according to claim 2, which is an optical pressure-sensitive adhesive sheet.

7. The pressure-sensitive adhesive sheet according to claim 3, which is an optical pressure-sensitive adhesive sheet.

8. The pressure-sensitive adhesive sheet according to claim 4, which is an optical pressure-sensitive adhesive sheet.
